(19) United States
(12) Patent Application Publication
(10) Pub. No.: US 2015/0032428 A1
(43) Pub. Date: Jan. 29, 2015

(54) NETWORK SELECTION METHOD IN WIRELESS COMMUNICATION NETWORK AND WIRELESS COMMUNICATION NETWORK SYSTEM

(71) Applicant: Japan Science and Technology Agency, Saitama (JP)

(72) Inventors: Mikio Hasegawa, Tokyo (JP); Takumi Matsui, Tokyo (JP)

(21) Appl. No.: 14/382,752

(22) PCT Filed: Feb. 28, 2013
(86) PCT No.: PCT/JP2013/055306

§ 371 Date: Sep. 3, 2014

(30) Foreign Application Priority Data
Mar. 5, 2012 (JP) 2012-048570

(51) Int. Cl. G06F 17/10

(52) U.S. Cl. CPC G06F 17/10; H04W 48/18
USPC 703/2

(57) ABSTRACT

An object of the present invention is to optimize fairness of throughput in terminal devices in a wireless communication network, and to provide a technique for selecting combinations of the terminal devices and wireless network access.

A method of selecting a destination network that optimizes throughput fairness of terminal devices in a wireless communication network system including a plurality of wireless access networks, and terminal devices that correspond to a plurality of types of wireless access networks, including: modeling a problem combining terminal devices to be optimized and a connection target network, as a minimum cost flow problem; calculating an exact solution of the minimum cost flow problem by computer operating means; and calculating the results of combining the terminal devices and the connection target network using network selection results operating means of a computer.

### FIELD OF THE INVENTION

The present invention relates to a network selection method in a wireless communication network, and more particularly relates to a selection method of a destination network that optimizes fairness of throughput in terminal devices.

### BACKGROUND OF THE INVENTION

Research related to recent cognitive wireless technology is being evaluated as a technology that efficiently uses a limited wireless resource. For example, Non-patent Literature 1 discloses research of a software wireless technology that can connect to different wireless interfaces to change to a different wireless system.

Furthermore, a peripheral technology being developed, such as research of a technology that seamlessly hands over a different wireless network (refer to Non-patent Literature 2 and 3) or the like.

Wireless selection depending on the situation and the communication quality and fairness can be improved with the heterogeneous type cognitive wireless technology that actively uses a terminal that can connect to a different wireless network. As a specific example, a large scale empirical experiment that uses a cognitive wireless router is currently in progress. (Refer to Non-patent Literature 4).

The combinations of wireless access network selection problems that come with these systems, such as load distribution and the like, increases tremendously in conjunction with an increase in the number of terminals and base stations, and has become a NP difficult problem for which exact solutions cannot be attained within a realistic time period.

Because of these problems, existing methods include a wireless terminal automatically selecting a base station or implementing a neural network.

For example, Non-patent Literature 5 discloses a cognitive wireless architecture where a cognitive wireless terminal that can connect to a variety of networks with a plurality of wireless access methods and automatically gathers network information that can be used on site, attains wireless accesses and networks QoS information in real-time, and optimizes the capacity and error ratio of the network as a whole.

Furthermore, IEEE 1900.4, a standard specification that defines the basic architecture and functions and tries to use wireless resources optimally by distributing the decision-making to the network and the terminal, was disclosed on Feb. 27, 2009. (Refer to Non-patent Literature 6).

Patent Document 1 discloses a configuration of a wireless connection terminal connected to a wireless base station where neurons firing decisions are made in a neural network calculating device where neuronal firing is associated with selection of the wireless base station selection, in a wireless communication network system that automatically selects the wireless base station to which the wireless communication terminal connects.

Patent Document 2 discloses a technology that distributes the load of the wireless network by switching the access point when the difference of the delay cost between the two access points and the cost when switching the access point are compared, and the former exceeds the cost of the latter.

Furthermore, a decentralized base station selection architecture is disclosed in Non-patent Literature.

On the other hand, there are general problems that are known regarding a flow network such as maximum flow problems, minimum cost flow problems, other various flow problems, circulation flow problems, and the like, and technology to resolve these problems by solution methods are being proposed as, for example, a network of a pipework of water pipes.

Patent Document 3 is an example thereof, and proposes drafting a dynamic planning value of a water conveyance amount, a water supply amount, and a water storage amount by selecting each element of a water supply system as arcs and nodes, and formulizing to a minimum cost flow problem.

### PRIOR TECHNOLOGY DOCUMENTS

### Patent Documents

[Patent Document 1] Japanese Unexamined Patent Application 2009-55467.

[Patent Document 2] U.S. Pat. No. 8,098,637.

[Patent Document 3] Patent No. JP 3425160.

### Non-Patent Literature

[Non-patent Literature 1] H. Harada, “Software defined radio prototype toward Cognitive Radio Communication Systems,” IEEE Dyspan 2005, Vol. 1, pp. 539-547, 2005.

[Non-patent Literature 2] G Wu, P. Havinga and M. Mizuno, “MIRAI Architecture for Heterogeneous Networks,” IEEE Comm. Mag., pp. 126-134, 2002.

[Non-patent Literature 3] M. Inoue, K. Mahmud, H. Murakami, M. Hasegawa and H. Morikawa, “Novel Out-Of-Band Signaling for Seamless Interworking between Heterogeneous Networks,” IEEE Wireless Commun., Vol. 11, No. 2, pp. 56-63, 2004.

[Non-patent Literature 4] K. Ishizu et al., IEICE Trans., E93-B,3311-3322, 2010.

[Non-patent Literature 5] M. Kuroda, Y. Murata, H. Harada, S. Kato, “Cognitive Wireless Cloud (1)˜Architecture˜,” IEICE, Software Wireless Research Conference, March 2007.

[Non-patent Literature 6] “IEEE Standard for Architectural Building Blocks Enabling Network-Device Distributed Decision Making for Optimized Radio Resource Usage in Heterogeneous Wireless Access Networks,” IEEE 1900.4-2009, February 2009.

[Non-patent Literature 7] Y. Fukuda, Y. Oie, “Decentralized access point selection architecture for wireless LANs” IEEE VTC2004-Fall, pp. 1103-1107, 2004.

[Non-patent Literature 8] A. V. Goldberg, J. Algorithms, 22, 1-29, 1997.

[Non-patent Literature 9] “Combinatorial Optimization—Theory and Algorithms,” Springer-Verlag Tokyo, November 2005.

[Non-patent Literature 10] M. Shigeno, “Network Optimization and Algorithm,” Asakura Shoten, October 2010.

[Non-patent Literature 11] S. Fujishige “Graph, Network, Combinational Analysis” 2.3, Kyoritsu Shuppan, April 2002.

[Non-patent Literature 12] K. Iwano, Recent Developments of the Network FLow Problem, Discrete Structures and Algorithm II (K. Iwano), pp. 79-154, Kindai kagaku sha, 1993.

[Non-patent Literature 13] M. Kubo, T. Matsui, A. Tamura, “Applied Mathematical Programming Handbook,” 9.5, Asakura Shoten, May 2002.

### SUMMARY OF THE INVENTION

In view of the foregoing, an object of the present invention is to optimize fairness of throughput in terminal devices in a wireless communication network, and to provide a technique for selecting combinations of the terminal devices and wireless network access.

The present invention use the following means to resolve the aforementioned problem.

In other words, the present invention provides a method of selecting a wireless communication network of a connection target that optimizes throughput fairness of terminal devices in a wireless communication network system including a plurality of wireless access networks, and terminal devices that correspond to two or more wireless access networks (hereinafter referred to as destination networks”).

In particular, the present invention is preferably applied in a cognitive wireless communication network where the plurality of terminal devices can be connected while switching different destination networks.

This method includes modeling a problem combining terminal devices to be optimized and a destination network, as a minimum cost flow problem; calculating an exact solution of the minimum cost flow problem by computer operating means; and calculating the results of combining the terminal devices and the connection target network using network selection results operating means of a computer.

The configuration can be such that if the communication capacity of a destination network L(k) connected to a terminal device k is C_{L(k)}, and the number of terminal devices that are connected to the destination network L(k) is N_{L(k)}, a target function F that optimizes the fairness of throughput when the number of terminal devices is M is defined as:

$$F = {\sum }_{k = 1}^{M} \frac{1}{{T}_{k}} = {\sum }_{k = 1}^{M} \frac{{N}_{L ( k )}}{{C}_{L ( k )}} \qquad [ Equation 1 ]$$

and a problem that combines the terminal devices and the destination network shown by this target function is modeled as a minimum cost flow problem; and in order to perform this modeling, the equation is converted to:

$$F = {\sum }_{k = 1}^{M} \frac{{N}_{L ( k )}}{{C}_{L ( k )}} = {\sum }_{j = 1}^{P} \frac{{N}_{j}^{2}}{{C}_{j}} = {\sum }_{j = 1}^{P} {\sum }_{n}^{ } \frac{2 n - 1}{{C}_{j}} \qquad [ Equation 2 ]$$

and operating means of a computer calculates an exact solution of the minimum cost flow problem, and thereby network selection results outputting means output the results of the combination of the terminal devices and the destination network.

The present invention can provide a selecting device for a wireless access network (hereinafter referred to as a destination network) that optimizes fairness of throughput of terminal devices in a wireless communication network system.

In other words, the present invention provides a computer equation storing means that stores an equation for modeling a problem combining terminal devices and a destination network to be optimized, as a minimum cost flow problem; computer calculating means for calculating an exact solution of the minimum cost flow problem based on the equation, and network selection results outputting means of a computer that output the results of combining the terminal devices and the connection target network.

The following equation can be used in the equation storing means of the network selecting device. If the communication capacity of a destination network L(k) connected to a terminal device k is C_{L(k)}, and the number of terminal devices that are connected to the destination network L(k) is N_{L(k)}, a target function F that optimizes the fairness of throughput when the number of terminal devices is M is defined by the aforementioned equation 1 and a problem that combines the terminal devices and the destination network shown by this target function is modeled as a minimum cost flow problem; and in order to perform this modeling, the equation is converted to the aforementioned equation 2 and stored.

Furthermore, the computer operating means calculates an exact solution of the minimum cost flow problem; and the network selection results operating means of the computer calculates the results of combining the terminal devices and the destination networks.

The present invention provides a wireless communication network system including a plurality of wireless access networks and a terminal device that corresponds to a plurality of types of wireless access networks, including: the network selecting device, wherein the terminal device and the wireless access networks are connected based on the output results of the network selecting device.

### EFFECT OF THE INVENTION

The present invention provides the following effects by providing the aforementioned configuration.

In other words, a method of modeling that can be applied to a minimum cost flow problem was created by considering the selection problem of the wireless access network for the wireless network that has been an existing NP difficult optimization problem. An algorithm that calculates the known exact solution exists for the minimum cost flow problem, and the exact optimization of the selection problem is made possible by using this algorithm.

The optimization of the throughput fairness for the terminal can be achieved by this method.

In particular, modeling was achieved as a minimum cost flow problem by considering a plurality of branches that have different costs in between a base station and the initial node, because a squared term cannot be used for the known solution method of the minimum cost flow problem.

### BRIEF DESCRIPTION OF THE DRAWINGS

FIG. 1 is a block diagram of a wireless communication network according to the present invention;

FIG. 2 is a flow chart illustrating a network selection method in a wireless communication network;

FIG. 3 is an explanatory diagram of minimum cost problems according to the present invention;

FIG. 4 is an explanatory diagram related to modeling a minimum cost problems according to the present invention;

FIG. 5 is a block diagram of an RAN selection device and terminal device according to the present invention;

FIG. 6 is a block diagram of an RAN selection device and base station according to the present invention; and

FIG. 7 is an experimental example of an RAN selection method according to the present invention.

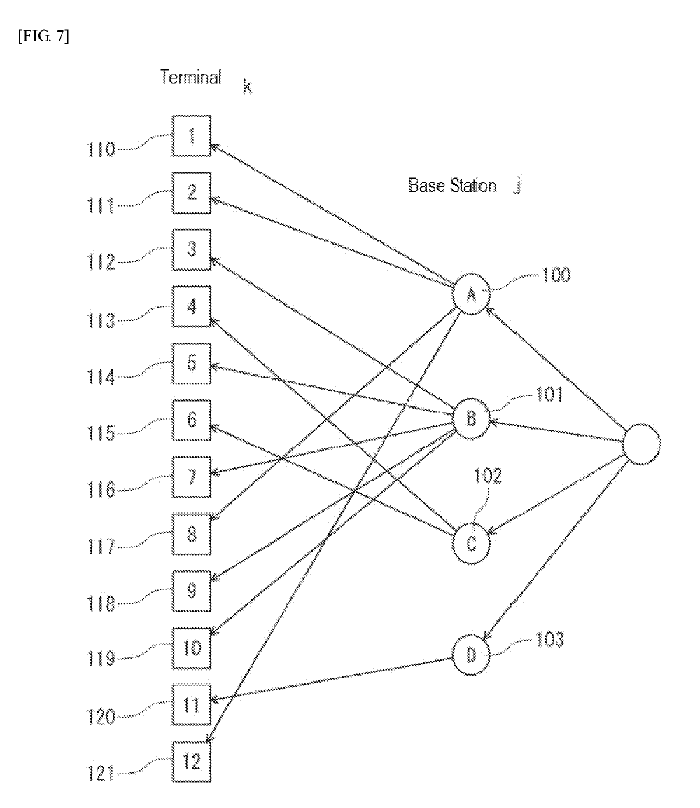

### DETAILED DESCRIPTION OF THE PREFERRED EMBODIMENTS

An embodiment of the present invention is described below based on the examples illustrated in the drawings. Note that an embodiment is not restricted to the following.

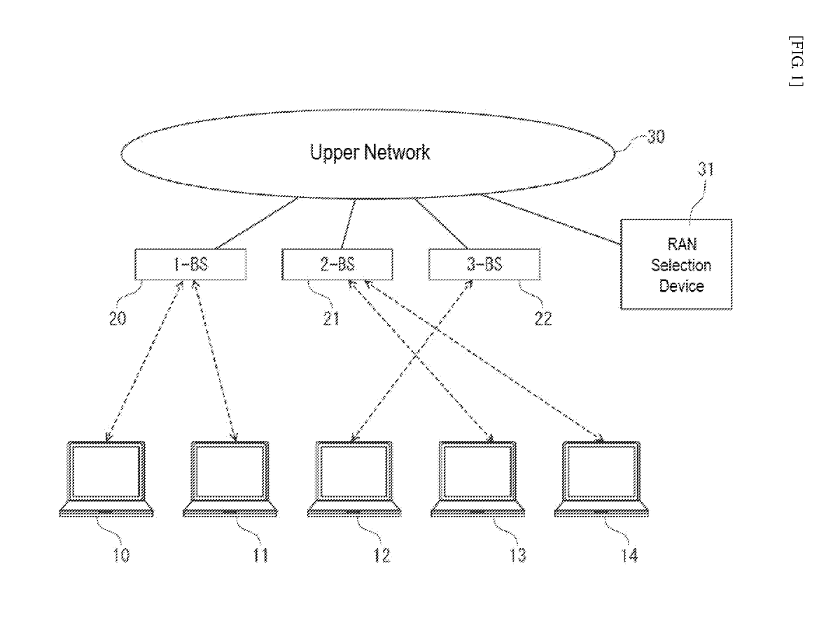

FIG. 1 is a block diagram of a wireless communication network according to the present invention. As illustrated, the embodiment is configured from a plurality of terminal devices (10) (11) (12) (13) (14), base stations (20) (21) (22), a higher network (30) such as the Internet connecting the base stations or the like, and a wireless network access (referred to hereinafter as RAN.) selection device (31) according to the present invention.

For a wireless communication network system, the terminal devices can connect to a plurality of various RAN even if the communication systems or the like are different. Communication is performed while switching the RAN to be connected based on the timing. A conventionally known method can be used as the method of switching the connection during communication.

An example of the present invention describes one RAN and one base station that correspond, but a different RAN can be configured in one base station. In other words, in some cases the frequency and modulation method differ, and an RAN providing a difference in communication capacity for each channel can be used.

FIG. 1 illustrates a state where terminal devices (10) (11) are connected to base station (20), terminal device (12) is connected to base station (22), and terminal devices (13) (14) are connected to base station (21). The base station has different communication capacity depending on various factors such as processing power, circuit with the upper network (30), or the like, and therefore, a base station with a high communication capacity can obtain sufficient throughput in each terminal even if simultaneously connected to a plurality of terminal devices, but there is a problem where the throughput is reduced when connected to a plurality when using a base station with low communication capacity.

From the perspective of the overall system, optimizing the throughput fairness of each terminal device is one solution for the RAN selection optimization problem of the network, and determining a solution by defining the objective function thereof is proposed by the present invention.

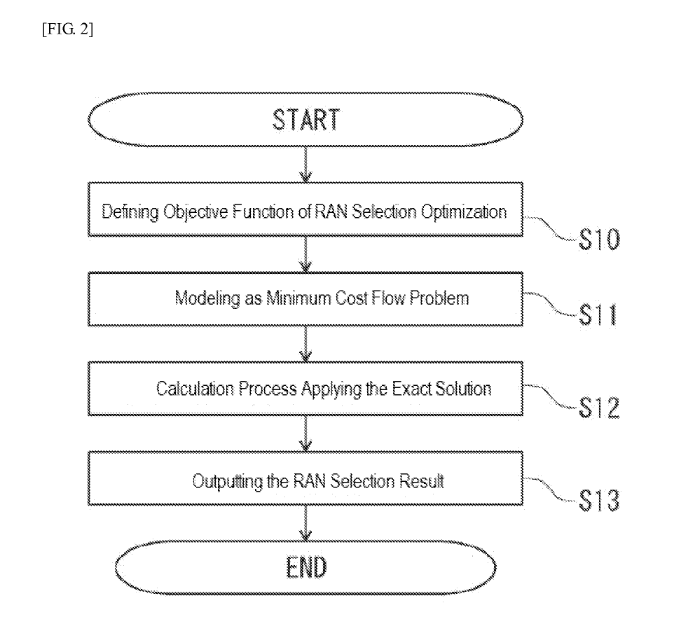

FIG. 2 is a flow chart illustrating a network selection method in a wireless communication network according to the present invention. Descriptions are made below based on the flow chart.

First, an objective function F of RAN selection optimization is defined. When communication capacity Cⱼ of base stations j are provided, a description state where the throughput difference between the terminal devices is the smallest is determined However, the base stations are assumed to evenly distribute radio resources to all connected terminal devices.

In other words, if the number of terminals that are connected to j is Nj, the throughput of terminal k that is connected to the same base station j can be expressed as:

$$F = {\sum }_{k = 1}^{M} \frac{1}{{T}_{k}} = {\sum }_{k = 1}^{M} \frac{{N}_{L ( k )}}{{C}_{L ( k )}} \qquad [ Equation 1 ]$$

Note that M is the number of terminals, and L(k) is a base station to which terminal k connects. The function F is a minimum when Tₖ are all equal. The problem is expressed as a combination optimization problem that determines a destination base station for each terminal

The target function of RAN selection optimization is defined as described above (S10).

Next, a minimum cost flow problem is modeled (S11). The objective is to convert the problem to a minimum cost flow problem where an exact solution exists because the RAN selection problem is an NP hard problem as described above.

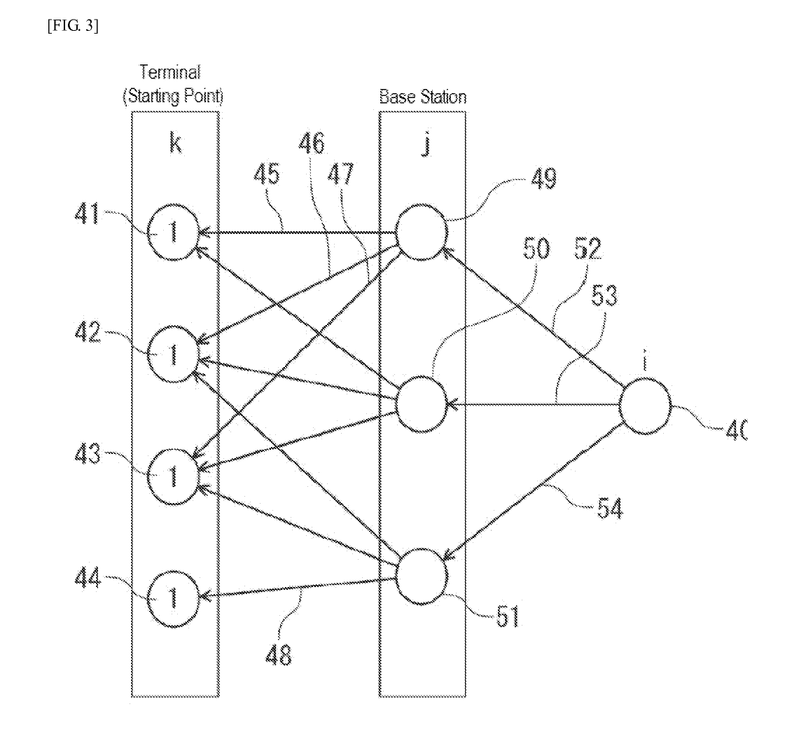

A minimum cost flow problem is a problem of determining the allotment for the amount of flow to each branch in order to minimize the total cost, when the flow flows from a starting point (40) of the network to each end point (41) through (44) as illustrated in FIG. 3. When the cost costⱼ of each branch, the capacity of each branch, and the amount of flow to flow to each end point k are provided, a flow xl is determined for each branch in order to minimize the sum of the cost F=Σ₁ cost₁×x₁.

Because there is an exact solution for the minimum cost flow problem, an exact solution can be achieved when reducing to the RAN selection problem of interest. An algorithm for determining the exact solution of the minimum cost flow problem is disclosed in cited document 8 according to A. V. Goldberg for example, and the present invention appropriately uses a conventionally known solution, and therefore, a description is omitted.

In this document, the difference in calculation speed by the algorithm was tested, but a CS (cost scaling) method that is generally capable of the fastest calculation was used in the present invention.

Note that Non-patent Literatures 9 through 13 also disclose the minimum cost flow problem.

With the present invention, the RAN selection problem is modeled as the minimum cost flow problem, and strictly optimized. The terminal devices are connected by selecting any base station, and therefore, the capacity of the branches (45) (46) (47) . . . (48) between the base stations (49) through (51) and the terminal devices are all set as 1.

The cost corresponding to the throughput reduction is assigned to each branch (52) through (54) between the base station and the starting point. Equation 1 is modified to a sum related to the base station j, and when adjusted, the equation becomes equation 3. Herein, P is the number of base stations.

$$F = {\sum }_{k = 1}^{M} \frac{{N}_{L ( k )}}{{C}_{L ( k )}} = {\sum }_{j = 1}^{P} \frac{{N}_{j}^{2}}{{C}_{j}} \qquad [ Equation 3 ]$$

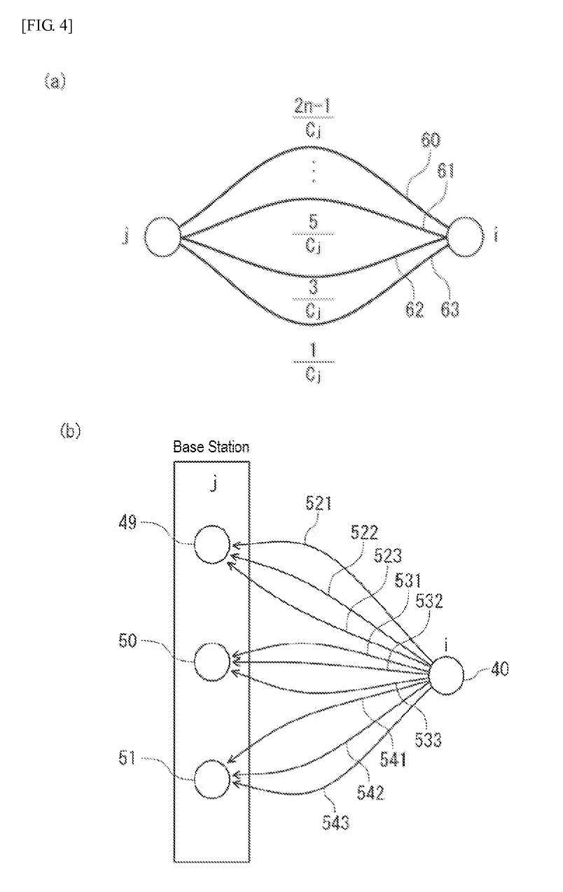

Herein, the minimum cost flow problem cannot use squared terms. Therefore, the number of branches (60) to (63) is prepared for the maximum number of terminals that can be connected to a base station as illustrated in FIG. 4(a) between each base station and a starting point, and each branch is assigned a cost of (2n−1)/Cⱼ. The squared term can be expressed by this sum. The target function is expressed as follows based on modification.

$$F = {\sum }_{j = 1}^{P} \frac{{N}_{j}^{2}}{{C}_{j}} {{\sum }_{j = 1}^{P} {\sum }_{n}^{ }}^{ } \frac{2 n - 1}{{C}_{j}} \qquad [ Equation 4 ]$$

When applied on a branch between the starting point and base station illustrated in

FIG. 3, branches (521) through (543) as illustrated in FIG. 4(b) are taken into account.

A major feature of the present invention is that the solution for the minimum cost flow problem can be used by modeling the RAN selection optimization problem using this improvisation.

A branch with minimum cost is automatically selected, because the optimization algorithm is calculated from the smallest branch.

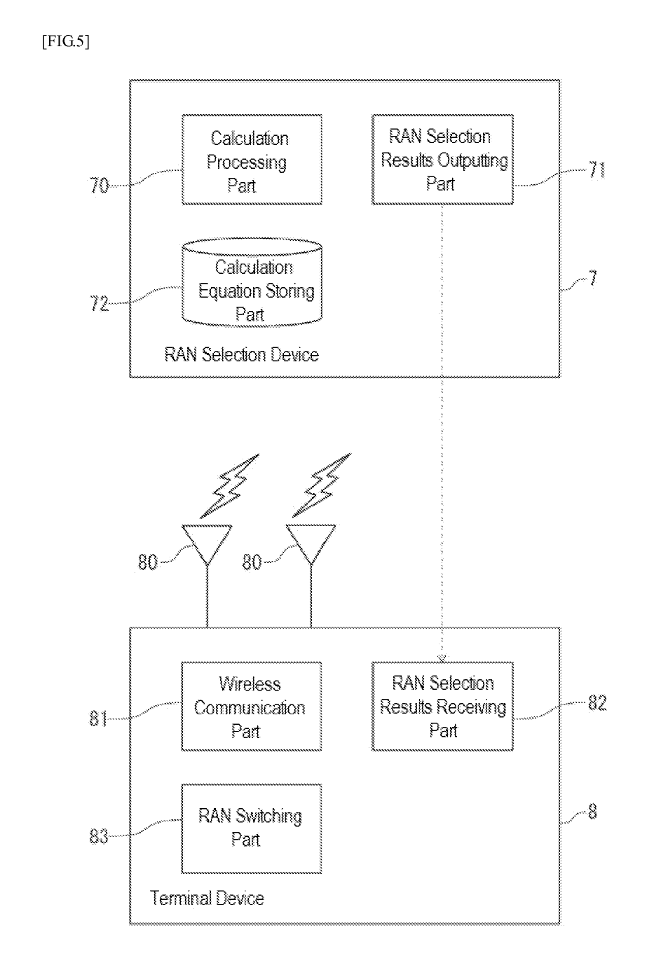

FIG. 5 is a block diagram of a RAN selecting device (7) and a terminal device (8) according to the present invention; The RAN selection device (7) is connected to the upper network as illustrated in FIG. 1, and is implemented using a conventionally known personal computer or the like. Furthermore, a calculation processing part (70) which is computing means, an RAN selection results outputting part (71) which is

RAN selection results outputting means, and calculation equation storing part (72) which is calculation equation storing means are at least provided.

The terminal device (8) is a conventionally known communication terminal such as a personal computer, mobile phone, smart phone, or the like, and provides an antenna (80), a wireless communication part (81), an RAN selection results receiving part (82), and an RAN switching part (83) for wirelessly communicating with the RAN. When corresponding to wireless access networks with different frequencies, a plurality of antennas (80) can be provided corresponding thereto.

Furthermore, a problem combining terminal devices to be optimized and a base station (connection target network) are modeled as minimum cost flow problems, and a calculation equation is stored in the calculation equation storing part (72) of the RAN selection device (7). With the calculation processing part (70), an exact solution for the minimum cost flow problem is calculated in accordance with a conventionally known algorithm determining the aforementioned exact solution from the calculation equation. (FIG. 2, S12).

Furthermore, results combining terminal devices and a base station to be calculated are output by the RAN selection results outputting part (71). (S13)

The combination results are transmitted to the RAN selection results receiving part (82) of the terminal device (8) through the RAN during use with the upper network (30), and the RAN switching part (83) switches the base station destination base on the results.

Base on the aforementioned configuration, the RAN selection device (7) of the present invention calculates an exact solution for the RAN selection problem, and the terminal devices (8) can select the RAN based on the results. The exact solution optimizes the throughput fairness of the terminal devices in the overall system, and therefore, an optimized state is achieved as a result of switching base stations of the terminal devices (8).

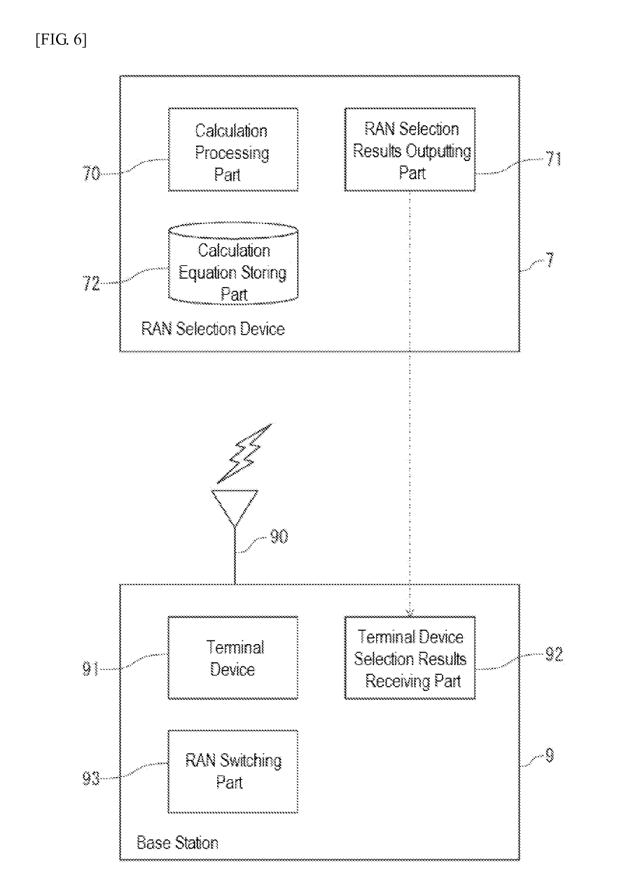

The exact solution of the minimum cost flow problem adopted by the present invention is capable of high speed processing, and contributes to a fast and accurate RAN selection. FIG. 6 is an alternative embodiment of the aforementioned, where the RAN selection device (7) transmits the RAN selection results to the base station (9), and the terminal device (8) connected to the base station is switched.

The base station (9) is a router or the like corresponding to communication having an antenna (90) and wireless communicating part (91), and provides a terminal device selection results receiving part (92) and terminal device switching part (93).

Furthermore, the aforementioned combination results is transmitted through the upper network (30) from the RAN selection results outputting part (71), and the terminal device selection results receiving part (92) receives the combination results. The terminal device switching part (93) switches the terminal device (8) to be connected based on the results.

With the present configuration, the throughput fairness of the terminal devices in the overall system is optimized in the same manner as described above.

Finally, an experimental example is presented where an algorithm that can be strictly acquired for a load distribution optimization problem is modeled using the present invention.

With the present experimental example, calculations are performed in an environment with four base stations (100) to (103) and twelve terminal devices (110) to (121).

The capacity of the base station A (100) and base station B (101) is 54 Mbps, the capacity of the base station C (102) is 21 Mbps, and the capacity of the base station D (103) is 11 Mbps.

Furthermore, an exact solution of the RAN selection problem according to the present invention was performed from inside the base station to which the terminals can connect, and a combination of the terminal devices and the base stations were calculated. Table 1 is shows the combination results.

TABLE 1

Capacity of Each
Base Station [Mbps]

| k No. | A (54) | B (54) | C (21) | D (11) |
|---|---|---|---|---|
| 1 | ∘ | | x | |
| 2 | ∘ | x | | |
| 3 | | ∘ | x | |
| 4 | x | x | ∘ | |
| 5 | x | ∘ | | x |
| 6 | | x | ∘ | x |
| 7 | | ∘ | x | |
| 8 | ∘ | | x | |
| 9 | | ∘ | | x |
| 10 | | ∘ | | x |
| 11 | | | | ∘ |
| 12 | ∘ | | | x |

In Table 1, communication terminal 1 (110) can be connected to the base stations A and C, and of these, is shown to be connected to the base station A (100). The communication terminal 2 (111) can be connected to the base stations A and B, and is connected to the base station A (100). The same applies to others.

In view of the foregoing, four and five terminal devices are set to connect to the base station A (100) and base station B (101) respectively with large capacities, two are set to connect to the base station C (102) with the next smallest base station, and one was set to connect to the base station D (103) with the smallest capacity.

Based on these results, the combination where fairness of throughput in a communication terminal connected to the base stations is achieved can be confirmed.

The present invention optimizes the load distribution of the wireless communication network system, and is not restricted to the selection problem of the base station. The wireless access network is not restricted to corresponding to one base station as described above, and if a plurality of access network is configured in one base station, the wireless access network can be used as a selection problem.

### DESCRIPTION OF CODES

10 to 14 Terminal Devices

20 to 22 Base Stations

30 Upper Network

31 RAN Selection Device

What is claimed is:

1. A network selection method for a wireless communication network which is a method of selecting a destination network that optimizes throughput fairness of terminal devices in a wireless communication network system including a plurality of wireless access networks, and terminal devices that correspond to a plurality of types of wireless access networks (hereinafter referred to as “destination network”), comprising:
modeling a problem combining terminal devices to be optimized and a connection target network, as a minimum cost flow problem;
calculating an exact solution of the minimum cost flow problem by computer operating means; and
calculating the results of combining the terminal devices and the connection target network using network selection results operating means of a computer.

2. The network selection method for the wireless communication network according to claim 1, wherein if the communication capacity of a destination network L(k) connected to a terminal device k is C_{L(k)}, and the number of terminal devices that are connected to the destination network L(k) is N_{L(k)}, a target function F that optimizes the fairness of throughput when the number of terminal devices is M is defined as:
$$F = {\sum }_{k = 1}^{M} \frac{1}{{T}_{k}} = {\sum }_{k = 1}^{M} \frac{{N}_{L ( k )}}{{C}_{L ( k )}} \qquad [ Equation 1 ]$$
1 and a problem that combines the terminal devices and the destination network shown by this target function is modeled as a minimum cost flow problem; and in order to perform this modeling, the equation is converted to:
$$F = {\sum }_{k = 1}^{M} \frac{{N}_{L ( k )}}{{C}_{L ( k )}} = {\sum }_{j = 1}^{P} \frac{{N}_{j}^{2}}{{C}_{j}} = {\sum }_{j = 1}^{P} {\sum }_{n}^{ } \frac{2 n - 1}{{C}_{j}} \qquad [ Equation 2 ]$$
and operating means of a computer calculates an exact solution of the minimum cost flow problem, and thereby network selection results outputting means output the results of the combination of the terminal devices and the destination network.

3. A network selection device for a wireless communication network which is a device of selecting a destination network that optimizes throughput fairness of terminal devices in a wireless communication network system including a plurality of wireless access networks, and terminal devices that correspond to a plurality of types of wireless access networks (hereinafter referred to as “destination network”), comprising:
equation storing means of a computer that stores an equation for modeling a problem combining terminal devices to be optimized and a connection target network, as a minimum cost flow problem;
operating means of a computer for calculating an exact solution of a minimum cost flow problem based on the equation; and
network selection result outputting means of a computer that outputs the results of combining the terminal devices and the connection target network.

4. The network selecting device for the wireless communication network according to claim 3, wherein if the communication capacity of a destination network L(k) connected to a terminal device k is C_{L(k)}, and the number of terminal devices that are connected to the destination network L(k) is N_{L(k)} in an equation storing means of the network selecting device, a target function F that optimizes the fairness of throughput when the number of terminal devices is M is defined as:
$$F = {\sum }_{k = 1}^{M} \frac{1}{{T}_{k}} = {\sum }_{k = 1}^{M} \frac{{N}_{L ( k )}}{{C}_{L ( k )}} \qquad [ Equation 1 ]$$
and a problem that combines the terminal devices and the destination network shown by this target function is modeled as a minimum cost flow problem; and in order to perform this modeling, the equation is converted to:
$$F = {\sum }_{k = 1}^{M} \frac{{N}_{L ( k )}}{{C}_{L ( k )}} = {\sum }_{j = 1}^{P} \frac{{N}_{j}^{2}}{{C}_{j}} = {\sum }_{j = 1}^{P} {\sum }_{n}^{ } \frac{2 n - 1}{{C}_{j}} \qquad [ Equation 2 ]$$
and stored, and the operating means of a computer calculates an exact solution of the minimum cost flow problem, and thereby network selection results outputting means output the results of the combination of the terminal devices and the destination network.

5. A wireless communication network system including a plurality of wireless access networks and a terminal device that corresponds to a plurality of types of wireless access networks, comprising:
the network selecting device according to claim 3 or 4,
wherein the terminal device and the wireless access networks are connected based on the output results of the network selecting device.
